(19) United States
(12) Patent Application Publication
(10) Pub. No.: US 2015/0042564 A1
(43) Pub. Date: Feb. 12, 2015

(54) PROJECTOR

(71) Applicant: SHARP KABUSHIKI KAISHA, Osaka-shi, Osaka (JP)

(72) Inventors: Hiroshi Shiina, Osaka-shi (JP); Sadahiko Shimazaki, Osaka-shi (JP)

(73) Assignee: SHARP KABUSHIKI KAISHA, Osaka-shi, Osaka (JP)

(21) Appl. No.: 14/384,990

(22) PCT Filed: Sep. 19, 2012
(86) PCT No.: PCT/JP2012/073882

§ 371 Date: Sep. 12, 2014

(30) Foreign Application Priority Data
Mar. 14, 2012 (JP) 2012-056684
Sep. 7, 2012 (JP) 2012-197403

(51) Int. Cl. G06F 3/03; G06F 3/042; G06F 3/0354; H04N 9/31

(52) U.S. Cl. CPC G06F 3/0304; H04N 9/3164; G06F 3/0421; G06F 3/03547; G06F 2203/04109; G06F 2203/0338
USPC 345/158; 353/81; 353/33

(57) ABSTRACT

A technology reducing the number of components in a projector. Illuminating light from a lamp is made incident from a first surface of a TIR prism via an optical system, reflected, output from a second surface of the TIR prism, optically modulated by a DMD, and made incident to the second surface of the TIR prism. Projection light from the DMD is transmitted through the TIR prism, emitted from a third surface of the TIR prism, and enlarged by a projection lens, to form an image on a screen. Light from a light emitting element is reflected by the screen, made incident to the third surface of the TIR prism via the projection lens, reflected, and output from a fourth surface of the TIR prism, to form an image on an imaging element.

### TECHNICAL FIELD

The present invention relates to a projector provided with an imaging function.

### BACKGROUND ART

Conventionally, some projectors are provided with an imaging function for causing light from a screen side to form an image on an imaging element and is used for an additional function such as a pointing device function or a photographing function. In such a projector, there is a technology that a projection lens for enlarging and projecting an image by an image display element such as a DMD (Digital Micromirror Device) on a screen is used also as image formation means for guiding the light from the screen side to the imaging element.

For example, in a technology of PATENT LITERATURE 1, an image which is optically modulated by a DMD is condensed by a first lens group via a TIR prism, reflected by a separating mirror, and projected on a screen by a third lens group. In the technology of PATENT LITERATURE 1, then, light from an infrared light emitting diode indicated on the screen is guided to the separating mirror by the third lens group, and the light from the infrared light emitting diode is transmitted through a wavelength selecting film provided on an incidence surface of the separating mirror to form an image on an imaging element via a second lens group.

### CITATION LIST

### Patent Literature

PATENT LITERATURE 1: Japanese Laid-Open Patent Publication No. 2009-205442

### SUMMARY OF INVENTION

### Technical Problem

In the technology described in PATENT LITERATURE 1, however, the separating mirror for separating the projection light by the DMD and the light from the screen is provided as an additional component. Therefore, costs and a size of a product increase in the technology of PATENT LITERATURE 1, including the additional component itself and a auxiliary component for retaining. Further, in the technology of PATENT LITERATURE 1, a space in which this additional component is inserted requires a fixed space between the lens groups, which imposes constraint for optical design and causes degradation of optical performance and increase in the number of lenses. Furthermore, in the technology of PATENT LITERATURE 1, because of this additional component, reflection and transmission loss are increased and light output of the projection light is decreased as well as astigmatism by a parallel plate of the separating mirror that is inserted obliquely is generated to degrade image formation performance.

Moreover, in the technology of PATENT LITERATURE 1, since an imaging function is realized by providing the additional component, also when a product not having an imaging function is developed on a common platform, extra costs are caused due to the additional component, the corresponding increase in the number of lenses for optical design and the like. Thus, in the technology of PATENT LITERATURE 1, it is difficult to develop a product having or not having an imaging function on the common platform, and investment efficiency is low.

The present invention has been made in view of the above-described problems, and aims to provide a technology by which the number of constituent components of a projector provided with an imaging function is able to be reduced.

### Solution to Problem

A projector of the present invention is a projector including a TIR prism that reflects light from a light source to guide to an optical modulation element and causes the light reflected by the optical modulation element to be transmitted to output to a projection optical system, and is characterized in that an imaging element is arranged in a reflecting direction of the light that is made incident to a reflective surface of the TIR prism from the projection optical system.

Moreover, a film that reflects infrared light may be provided on the reflective surface.

Moreover, a film in which a reflection rate of a part becoming a valley between spectrums of projection light becomes high may be provided on the reflective surface.

Moreover, the reflective surface may cause the light reflected by the optical modulation element to be transmitted to output to the projection optical system as well as reflect the light that is made incident from the projection optical system to guide to the imaging element depending on angle characteristics.

Moreover, light of a light emitting element that is irradiated on a screen may be reflected by the reflective surface of the TIR prism via the projection optical system and emitted from a surface on a side of the TIR prism, where the imaging element is arranged, to form an image on the imaging element.

Moreover, the surface on the side of the TIR prism, where the imaging element is arranged, may be vertical to center light of a photographed image.

Moreover, a wavelength band in which a reflection rate is high among reflection characteristics of the film provided on the reflective surface may be overlapped with a wavelength band of the light emitting element that irradiates the screen.

Moreover, an irradiation position detecting portion that obtains irradiation position information showing an irradiation position of the light emitting element on the screen from the imaged image that is imaged by the imaging element, an OSD drawing portion that generates an OSD image in which a predetermined pointing image is drawn corresponding to the irradiation position information, an image synthesizing portion that synthesizes the OSD image with a projected image projected on the screen via the projection optical system to generate a synthesized image, and the optical modulation element that performs optical modulation so as to project the synthesized image to emit to the TIR prism may be included.

### Advantageous Effect of Invention

According to the present invention, it is possible to reduce the number of constituent components of a projector provided with an imaging function.

### BRIEF DESCRIPTION OF DRAWINGS

FIG. 1 is a schematic configuration diagram of a projector of an embodiment according to the present invention.

FIG. 2 are enlarged diagrams of a TIR prism shown in FIG. 1.

FIG. 3 is a diagram showing reflective film characteristics provided on an O-surface shown in FIG. 2.

FIG. 4 are diagrams showing reflective film characteristics provided on the O-surface shown in FIG. 2.

FIG. 5 is an explanatory diagram when angle characteristics of the TIR prism shown in FIG. 1 are used.

FIG. 6 is another schematic configuration diagram of a projector of an embodiment according to the present invention.

FIG. 7 is a diagram showing a situation where light on a screen shown in FIG. 1 is guided to an imaging element.

FIG. 8 are diagrams showing reflection characteristics of the O-surface shown in FIG. 4 and wavelength characteristics of a light emitting element together.

FIG. 9 is a functional block diagram showing a configuration of the projector shown in FIG. 1.

FIG. 10 is a diagram showing a situation where a light emitting element is irradiated to a projected image projected on the screen.

FIG. 11 is a diagram showing an imaged image in which a light spot of the light emitting element shown in FIG. 10 is imaged.

FIG. 12 is a diagram showing an OSD image generated by an OSD drawing portion shown in FIG. 9.

FIG. 13 is a diagram showing a synthesized image generated by an image synthesizing portion shown in FIG. 9.

FIG. 14 is a diagram showing a projected image in which a pointing image is displayed being overlapped at an irradiation position of the light emitting element shown in FIG. 10.

### DESCRIPTION OF EMBODIMENTS

In a projector of the present embodiment, the number of constituent components when an imaging function is realized is able to be reduced by using a TIR prism for separating illuminating light and projection light also for separation of the projection light and image formation light for imaging. Description will hereinafter be given specifically for embodiments of the present invention with reference to drawings.

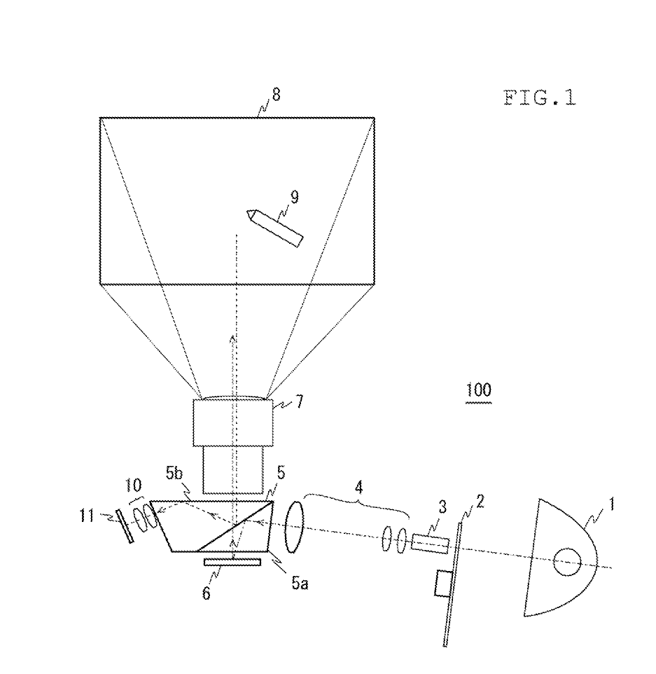

As shown in FIG. 1, a projector 100 is provided with a lamp 1, a color wheel 2, a rod integrator 3, a condenser lens 4, a TIR (Total Internal Reflection) prism 5, a DMD 6, a projection lens 7, a magnification correction optical system 10, and an imaging element 11.

Illuminating light output from the lamp 1 which is a light source is made incident to the color wheel 2.

The color wheel 2 has red, blue and green filters and rotates at high speed by being driven by a not-shown motor. When the color wheel 2 rotates, the filters of three colors are switched in a short time. Thereby, the illuminating light is subjected to color separation into the three colors of R (red) light, B (blue) light and G (green) light by time sharing. The separated light of each color is made incident to the rod integrator 3 successively.

The rod integrator 3 is a quadrangular prism-shaped lens made of glass or the like, totally reflects incident light in the inside thereof, and outputs light having uniform illumination distribution. The light output from the rod integrator 3 is guided by the condenser lens 4, which is configured by a plurality of lenses, so as to be irradiated onto the DMD 6 with an appropriate size, and is made incident to the TIR prism 5.

The TIR prism 5 is configured by a first prism 5a and a second prism 5b, and a reflective surface is formed on a border of the two prisms. Incident light from the condenser lens 4 with respect to this reflective surface provided inside the TIR prism 5 has an incident angle which is equal to or more than a critical angle, and is therefore totally reflected to be guided to the DMD 6.

The DMD 6 is a type of an optical modulation element (light valve) in which a lot of micro mirrors are arranged in a plane. The DMD 6 spatially applies optical modulation to the light of red, green and blue, which is subjected to time sharing for irradiation, based on an image signal from outside to generate projection light. The projection light by the DMD 6 is made incident at an incident angle smaller than the critical angle to the reflective surface of the TIR prism 5. Therefore, the projection light by the DMD 6 is transmitted through the reflective surface and made incident to the projection lens 7. The projection light is enlarged and projected by the projection lens 7 and forms an image on the screen 8.

A user is able to indicate an arbitrary position on the screen 8 via a light emitting element 9 that emits light such as infrared ray. The light reflected by the screen 8 is made incident to the TIR prism 5 via the projection lens 7.

The light from the screen 8, which is made incident to the TIR prism 5, is reflected by the reflective surface of the TIR prism 5 as well as reflected inside the TIR prism 5, and emitted from the TIR prism 5. The light emitted from the TIR prism 5 is guided to the imaging element 11 configured by a CCD (Charge Coupled Device), a CMOS (Complementary Metal Oxide Semiconductor) and the like via a plurality of lenses serving as the magnification correction optical system 10, and forms an image on the imaging element 11.

Thereby, processing such as for detecting a position where infrared light is irradiated on the screen 8 and projecting a pointing image which shows being indicated by the user or the like on the screen 8 via the DMD 6 for feedback is performed by an image processing portion described below.

Note that, the plurality of lenses serving as the magnification correction optical system 10 may be inserted between the TIR prism 5 and the imaging element 11 when a size of the DMD 6 and a size of the imaging element 11 are not matched or when a projection system and an image formation system need to have different magnifications. That is, when the size of the DMD 6 and the size of the imaging element 11 are matched or when the projection system and the image formation system do not need to have different magnifications, it is possible to reduce costs by omitting the magnification correction optical system 10.

In this manner, the present embodiment, in the projector 100 of a front projection type, illuminating light and projection light are separated as well as the projection light and image formation light for imaging are separated by the TIR, prism 5. The image formation light for imaging (light from the screen 8 side) is guided to the imaging element 11 by using a surface of the TIR prism 5 that is not used normally. Therefore, since the additional component for the imaging function does not need to be provided, it is possible to realize reduction in costs and a size of a product, prevention of degradation of optical performance, and the like.

The TIR prism 5 will be described specifically.

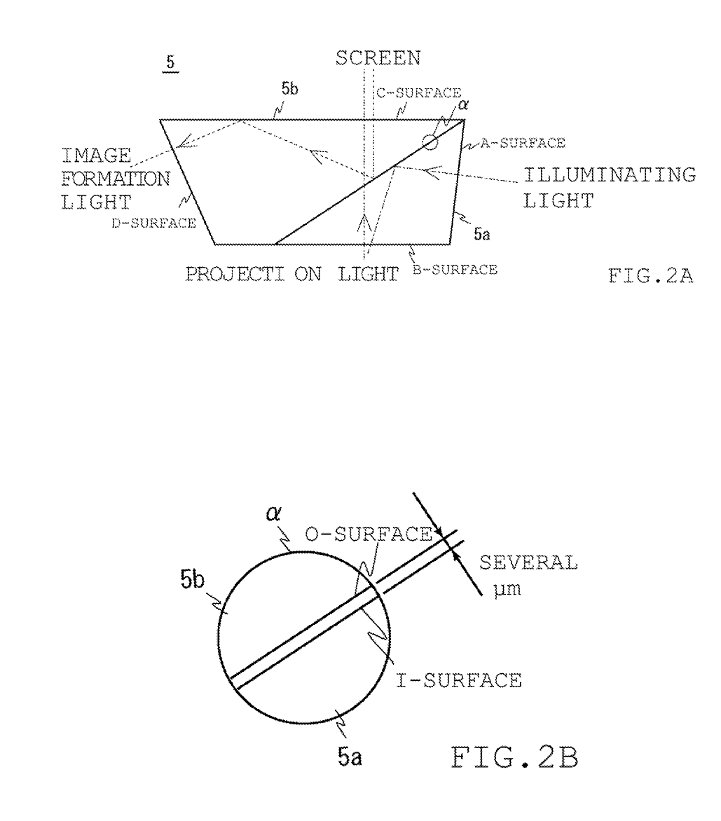

FIG. 2 are enlarged diagrams of the TIR prism 5. As shown in FIG. 2A, the TIR prism 5 is configured by the first prism 5a and the second prism 5b. FIG. 2B is an enlarged diagram of α shown in FIG. 2A. As shown in FIG. 2B, the TIR prism 5 has an I-surface of the first prism 5a and an O-surface of the second prism 5b arranged in parallel with a gap of several μm.

Illuminating light from the lamp 1 is made incident to an A-surface of the first prism 5a via an illuminating optical system such as the condenser lens 4, reflected by the I-surface of the first prism 5a, and output from a B-surface of the first prism 5a toward the DMD 6. The illuminating light is optically modulated by the DMD 6 and made incident from the B-surface of the first prism 5a as projection light. The projection light which is made incident from the B-surface is output from the I-surface of the first prism 5a, made incident to the O-surface of the second prism 5b, output from a C-surface of the second prism 5b, and forms an image on the screen 8 via the projection lens 7.

The light reflected by the screen 8 is made incident from the C-surface of the second prism 5b via the projection lens 7, reflected by the O-surface of the second prism 5b, and output from a D-surface of the second prism 5b toward the imaging element 11 through internal reflection of the second prism 5b. Note that, it is needless to say that the light reflected by the O-surface of the second prism 5b may not be through the internal reflection of the second prism 5b, if the imaging element 11 is arranged in an optical path thereof.

That is, on the I-surface of the first prism 5a, the illuminating light which is made incident from the light source side is reflected to be made incident to the DMD 6 as well as a projected image which is optically modulated by the DMD 6 is transmitted to be guided to the O-surface. Moreover, on the O-surface of the second prism 5b, the projected image of the DMD 6, which is made incident from the I-surface side, is transmitted as well as the light which is made incident from the screen 8 side is reflected and reflected inside the second prism 5b to be guided to the imaging element 11. Note that, an example where the TIR prism 5 is configured by the first prism 5a having a triangular surface and the second prism 5b having a quadrilateral surface is illustrated in the diagram, which may be another shape without limitation thereto. In other words, the TIR prism 5 is only required to have a reflective surface that is formed so as to reflect illuminating light to guide to the DMD 6 as well as cause light reflected by the DMD 6 to be transmitted to output to the projection lens 7, so that the light which is made incident from the projection lens 7 is able to be reflected by the reflective surface to guide to the imaging element 11.

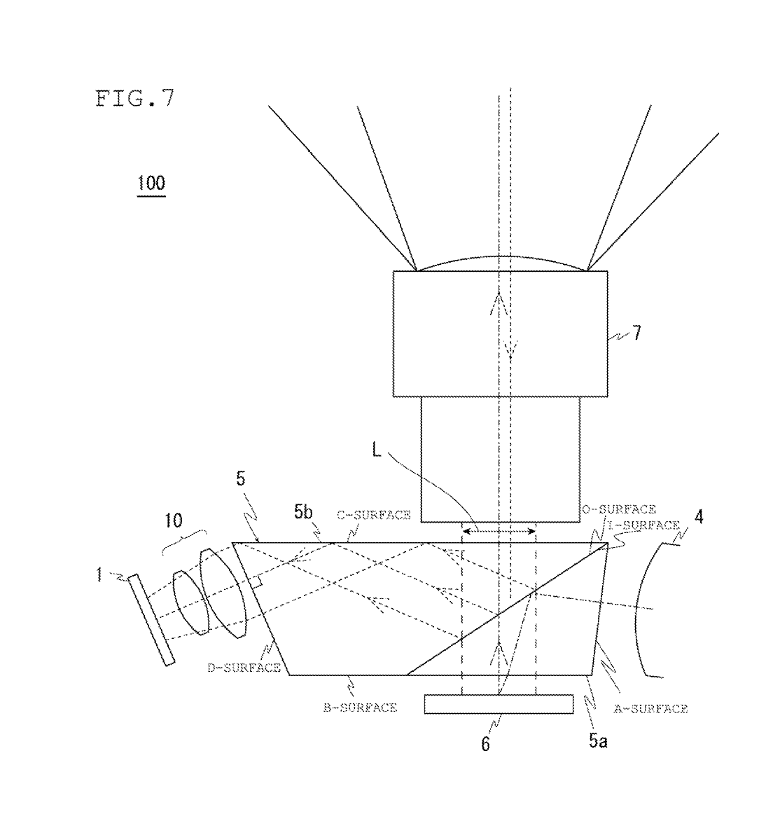

Specifically, description will be given for a situation where light on the screen 8 is guided to the imaging lens 11 with reference to FIG. 7. Light reflected by the screen 8 is made incident from the C-surface of the second prism 5b via the projection lens 7 and reflected by the O-surface. At this time, light in a range of L as illustrated in the diagram is reflected by the O-surface. This range of L corresponds to a screen area by the DMD 6. The light reflected by the O-surface is then internally reflected by the C-surface and reaches the D-surface. The light reaching the D-surface is transmitted through the D-surface, guided to the imaging element 11 via the magnification correction optical system 10, and captured by the imaging element 11.

This D-surface is disposed vertically to a light axis of image formation light for imaging (imaging light) guided to the imaging element 11 (center light of a photographed image). Moreover, in the diagram, a side of the TIR prism 5 of the magnification correction optical system 10 serves as an optical system to be telecentric. That is, a shape keeping being telecentric is given up to the magnification correction optical system 10 which is a correction lens on the imaging element 11 side. In this case, the DMD 6 side of the projection lens 7 is telecentric in the same manner in normal design. Therefore, it becomes possible to guide imaging light onto the imaging element 11 efficiently across an entire area on a screen.

Moreover, when the D-surface is disposed vertically to the light axis of the imaging light in this manner, symmetry property with respect to the light axis is maintained and aberration caused by inclination of the light axis does not become generated. That is, astigmatism generated when non-telecentric light beam passes through the D-surface of the TIR prism does not become generated in principle. Thus, an imaged image becomes sharp as well as uniformity of the entire imaged image is maintained.

Note that, when an NA (opening) on the imaging element 11 side is sufficiently small, it is not necessary to be always telecentric, but in order to improve sensitivity by increasing the NA on the imaging element 11 side, it is more efficient when telecentric is maintained as illustrated in the diagram.

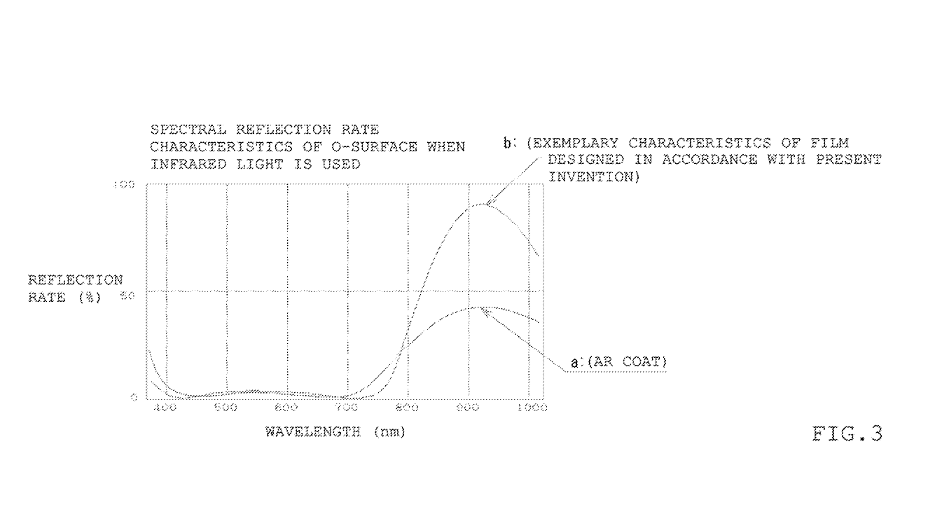

Further, at this time, the O-surface of the second prism 5b is only required to be able to reflect infrared ray as a wavelength of the light emitting element 9 efficiently to guide to the imaging element 11. FIG. 3 is a diagram of spectral reflection rate characteristics of the O-surface. The reflection rate characteristics when an AR coat (reflection preventive film) for normal visible light is provided on the O-surface are denoted as a. The AR coat reflects about 40% of infrared ray (near 900 nm) and is therefore able to establish an optical system. Moreover, as shown with b, a film which is specially designed in accordance with the present embodiment so as to increase a reflection rate with respect to infrared ray may be provided on the O-surface. In this case, as to the film shown with b, about 80% of infrared ray is reflected and the reflection rate for infrared ray is about twice of that of the AR coat shown with a.

Note that, the projection lens 7 needs to cause infrared ray from the screen 8 to be transmitted to guide to the O-surface. The projection lens 7 is configured by a plurality of lenses in many cases, so that the infrared ray has a less transmission rate as being transmitted through each lens. Therefore, the projection lens 7 may be provided with not the AR coat but a film that is specially designed so as to cause the infrared ray to be transmitted.

Moreover, not only the infrared ray but visible light may be guided to the imaging element 11. In this case, the film of a or b shown in FIG. 3 may use the reflection rate for visible light which exists on the O-surface at several % (near 400 nm to 700 nm) and reflect the visible light to guide to the imaging element 11.

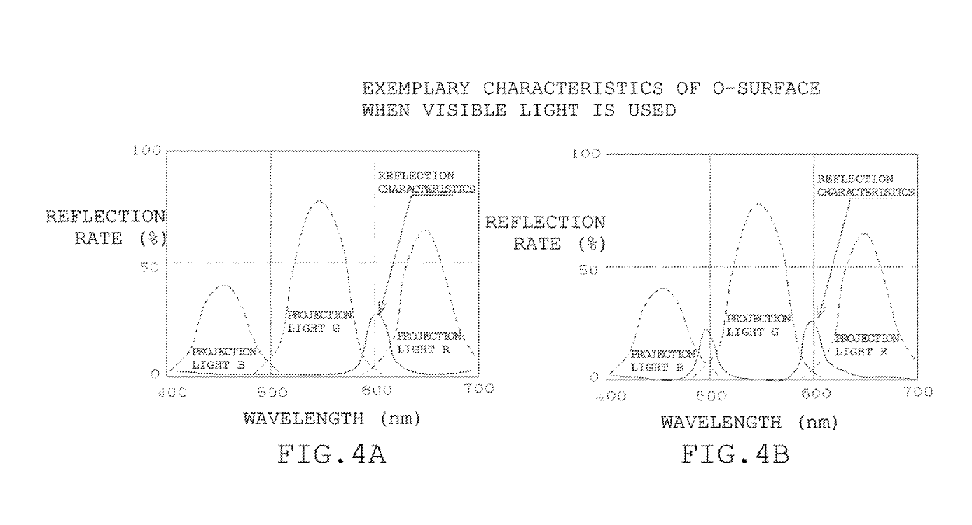

Further, the visible light of a part becoming a valley between spectrums of each projection light R, G and B may be reflected to be guided to the imaging element 11. In FIG. 4, reflection characteristics of a film provided on the O-surface for reflecting the visible light are shown by solid lines and output characteristics of each projection light R, G and B are shown by dotted lines for reference.

In FIG. 4A, the film provided on the O-surface is designed so that the reflection rate near 600 nm becoming a valley between spectrums of projection light G and projection light R becomes high. This makes it possible to cause projection light from the DMD 6 side to be transmitted through the O-surface as well as reflect the visible light near the valley between spectrums of the projection light G and the projection light R among light from the screen 8 side by the O-surface. Thereby, it is possible to separate projection light and image formation light (light from the screen 8) efficiently and guide the light from the screen 8 to form an image on the imaging element 11.

Note that, as shown in FIG. 4B, the film provided on the O-surface may be designed so that the reflection rate becomes high both near 500 nm becoming a valley between spectrums of projection light B and the projection light G and near 600 nm becoming the valley between spectrums of the projection light G and the projection light R, or may be designed so that the reflection rate becomes high in either of them.

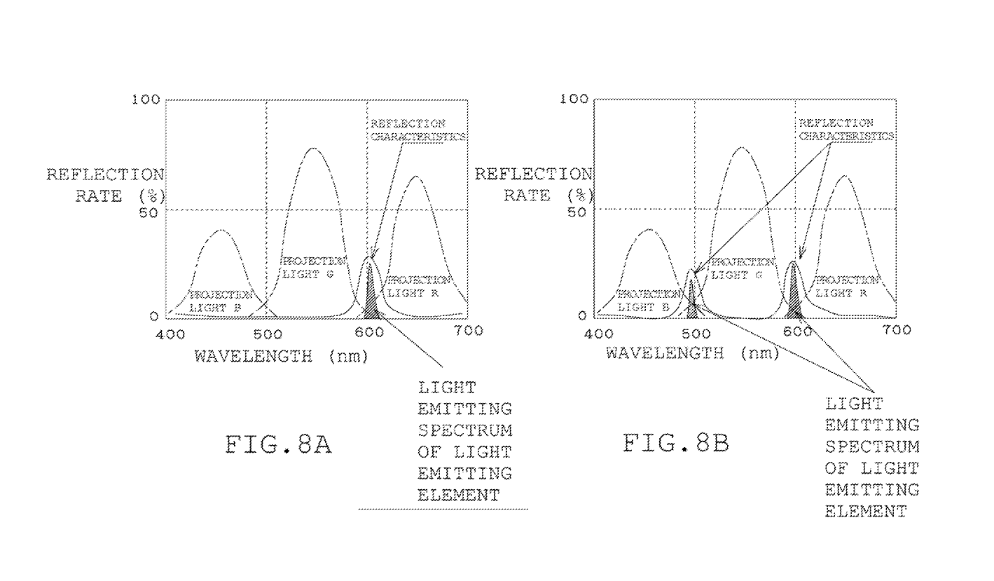

That is, the film provided on the O-surface is designed so as to reflect wavelength bands near the valleys between spectrums of the projection light G, B and R. Therefore, as shown in FIG. 8, by overlapping a wavelength band of the light emitting element 9 which is a pointing device (shaded area in the diagrams) and a wavelength band in which the reflection rate of the film on the O-surface is increased, light of the light emitting element 9 reflected by the screen 8 is guided to the imaging element 11 without being affected by a projected image. Therefore, the image processing portion described below is able to obtain irradiation position information of the light emitting element 9. Note that, FIG. 8A corresponds to FIG. 4A and FIG. 8B corresponds to FIG. 4B.

Moreover, as shown in FIG. 8B, when the film on the O-surface is designed so that the reflection rate becomes high both near 500 nm and near 600 nm, both of the light emitting element 9 with the wavelength near 500 nm and the light emitting element 9 with wavelength near 600 nm are able to be used. In this case, a color filter that causes wavelength matched with wavelength bands of the two light emitting elements 9 (near 500 nm and near 600 nm) to be transmitted, for example, by time sharing may be provided on the imaging element 11 side. In this manner, when the imaging element 11 is an element of a color type in accordance with the color filter, the two light emitting elements 9 having different wavelength bands become usable at the same time on the screen 8 without interfering with each other.

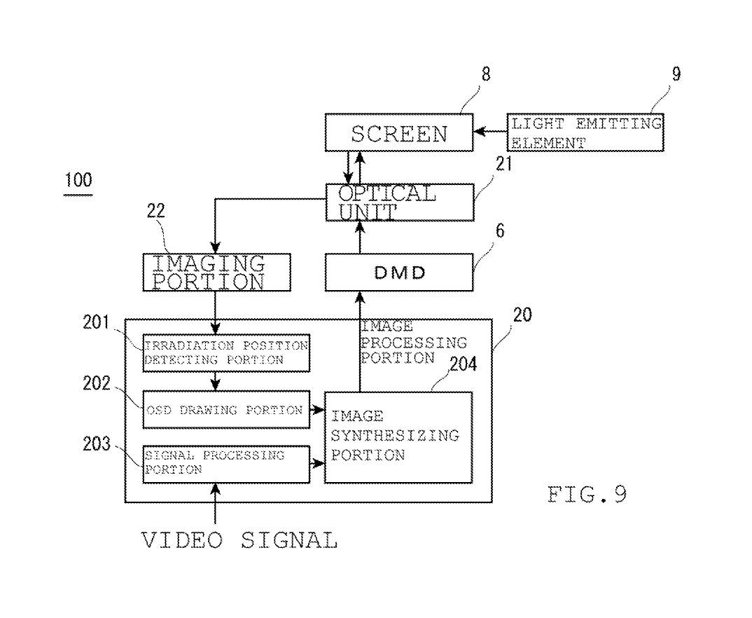

Next, description will be given for processing that an irradiation position of the light emitting element 9 is detected and a pointing image is projected on the screen 8 by the image processing portion with reference to FIG. 9.

FIG. 9 is a functional block diagram showing a configuration of the projector 100. In the diagram, the projector 100 is provided with an imaging portion 22, an image processing portion 20, the DMD 6, and an optical unit 21. Note that, the imaging portion 22 is a camera or the like and includes the imaging element 11, here. Moreover, it is set that the optical unit 21 includes the lamp 1, the color wheel 2, the rod integrator 3, the condenser lens 4, the TIR prism 5, the projection lens 7, and the magnification correction optical system 10.

The imaging portion 22 outputs an imaged image which is imaged by the imaging element 11 at every predetermined time or continuously to the image processing portion 20. In the imaged image, a light spot of the light emitting element 9, which shows a position where a user performs irradiation on the screen 8 using the light emitting element 9, is imaged.

The image processing portion 20 is provided with an irradiation position detecting portion 201, an OSD drawing portion 202, a signal processing portion 203, a video input portion, and an image synthesizing portion 204.

At each time obtaining the imaged image from the imaging portion 22, the irradiation position detecting portion 201 detects a position of the light spot in the imaged image, for example, based on change in luminance in the imaged image. The irradiation position detecting portion 201 outputs the detected position of the light spot, that is, irradiation position information to the OSD drawing portion 202.

The OSD drawing portion 202 generates an OSD image which is drawn so that a pointing image, for example, such as an arrow, is overlapped with the irradiation position on the screen 8 by the light emitting element 9 based on the irradiation position information.

The signal processing portion 203 obtains a video signal (image signal), for example, from a not-shown external memory, a computer and the like. The signal processing portion 203 then performs image adjustment for the obtained video signal so as to be an image suitable for projection to output to the image synthesizing portion 204.

The image synthesizing portion 204 synthesizes the OSD image obtained from the OSD drawing portion 202 and the video signal obtained via the signal processing portion 203. Thereby, a synthesized image in which the pointing image is synthesized with the video signal is generated. The image synthesizing portion 204 outputs the synthesized image which is generated to the DMD 6.

The DMD 6 causes the synthesized image obtained from the image synthesizing portion 204 to be projected on the screen 8 via the optical unit 21. As a result of this, a projected image in which the irradiation position of the light emitting element 9 and the pointing image are overlapped is displayed on the screen 8.

Specifically, description will be given for a situation where a pointing image is overlapped with an irradiation position of the light emitting element 9 on the screen 8 to be projected, with reference to FIG. 10 to FIG. 14.

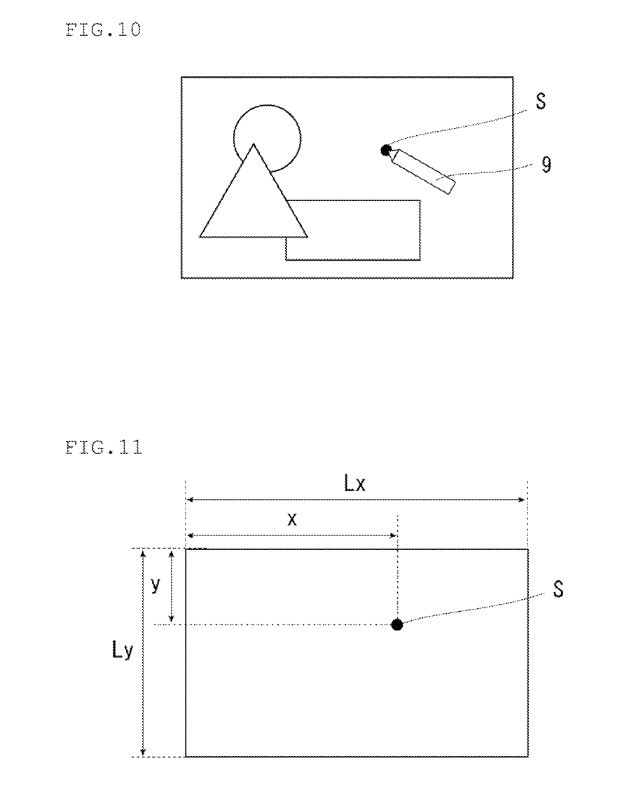

As shown in FIG. 10, it is set that a user irradiates a projected image on the screen 8 with infrared light or the like by using the light emitting element 9 to indicate an arbitrary place on the projected image. Then, as shown in FIG. 11, since only a wavelength of the light emitting element 9 is able to be received in the imaging portion 22, only a light spot S indicating the irradiation position of the light emitting element 9 is imaged. The irradiation position detecting portion 201 detects the light spot S, for example, based on change in luminance in the imaged image. The irradiation position detecting portion 201 then obtains it, for example, by regarding that when a size of the imaged image has a width Lx and a length Ly, the position of the light spot S is at x in width and y in length.

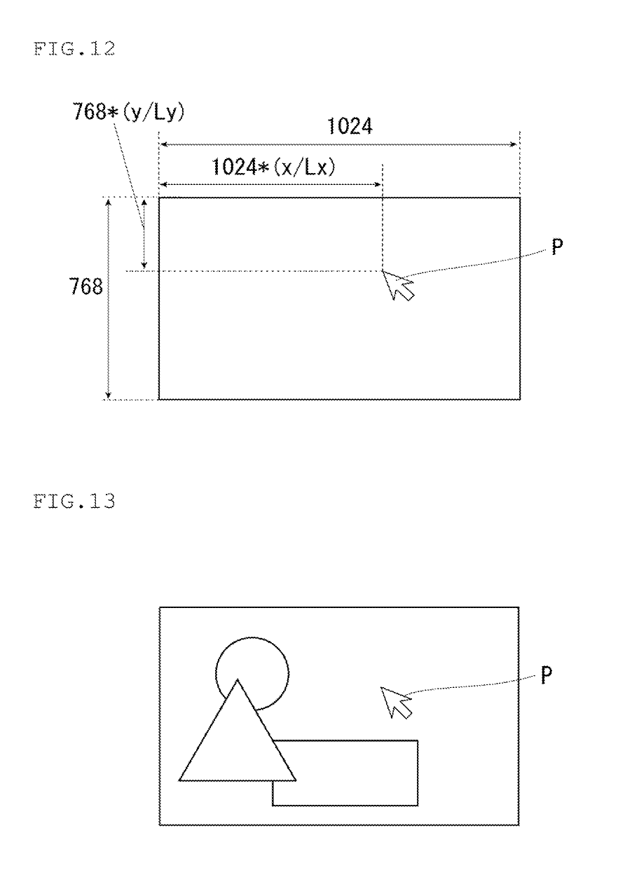

The OSD drawing portion 202 generates an OSD image in which a pointing image is drawn, based on position information (irradiation position information) of the light spot S obtained from the irradiation position detecting portion 201. For example, as shown in FIG. 12, when a resolution of the DMD 6 is XGA, an OSD image area of the OSD drawing portion 202 is 1024 in width×768 in length. In this case, the OSD drawing portion 202 generates an OSD image in which a pointing image P is drawn at a position of 1024×(x/Lx) in width and 768×(y/Ly) in length on the OSD image area. The OSD drawing portion 202 outputs the generated OSD image to the image synthesizing portion 204.

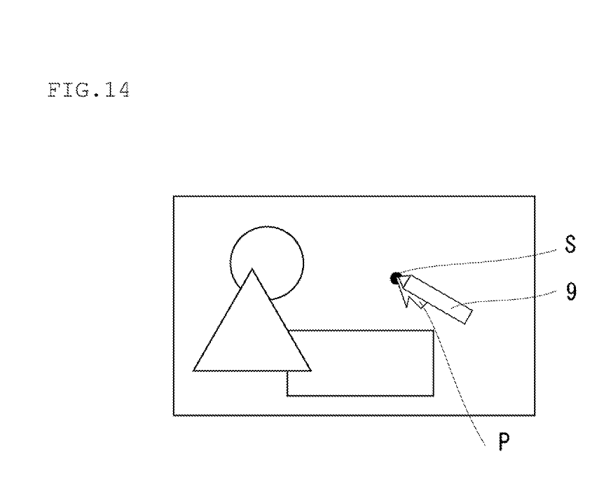

As shown in FIG. 13, the image synthesizing portion 204 generates a synthesized image in which the OSD image is synthesized with a video signal. This synthesized image is projected on the screen 8 via the DMD 6 and the optical unit 21. Then, as shown in FIG. 14, a projected image in which the pointing image P is overlapped at the irradiation position of the light emitting element 9 is displayed on the screen 8.

Note that, the pointing image P is set as being able to be changed by the user arbitrarily. Moreover, the pointing image P includes not only illustration and figures but also one indicating a trace of the irradiation position of the light emitting element 9 as a line. In addition, the image processing portion 20 may perform feedback of the irradiation position information detected by the irradiation position detecting portion 201 to an external computer for inputting the video signal or the like so that a mouse operation on a screen by the light emitting element 9 is able to be performed. That is, the projector 100 may function as an interactive projector provided with an electronic blackboard function. Moreover, the image processing portion 20 may store the synthesized image generated by the image synthesizing portion 204 in a not-shown memory so as to allow performing projection again.

Note that, as described above, it is possible to separate projection light and image formation light by providing the reflective film which is designed appropriately on the O-surface, which is able to be realized also by adjusting angle characteristics of the O-surface.

FIG. 5 is an explanatory diagram when angle characteristics of the TIR, prism 5 are used. Specifically, FIG. 5 is a diagram showing an arrangement relation of projection light, an effective light range for the imaging element 11 and a border showing a critical angle in an entrance pupil of the projection lens when the projection lens 7 is viewed from the DMD 6 side. When visible light is used, separation is possible also when projection light, image formation light and the critical angle are arranged as illustrated in the diagram. Though depending on an opening (NA) required on the imaging element 11 side, an angle of a reflective surface at this time is shifted as much as possible if sensitivity is sufficient, and the smaller the angle is, the less loss of the projection light becomes, thus being advantageous. Note that, for improvement of contrast, shifting is performed by 2 to 3 degrees in some cases and this range is the best. Moreover, depending on an angle of a light axis on the side of illuminating light which is made incident to the I-surface serving as the reflective surface, a stop having an opening which is skewed to the light axis on the side of the illuminating light may be arranged near a secondary light source image. According to this method, it is possible to guide light to the imaging element 11 across the entire area of the visible light and it is allowed to turn into full color. Note that, for turning into full color, a film that causes the projection light from the DMD 6 side to be transmitted and totally reflects light for the imaging element 11 from the screen 8 side may be provided on the reflective surface.

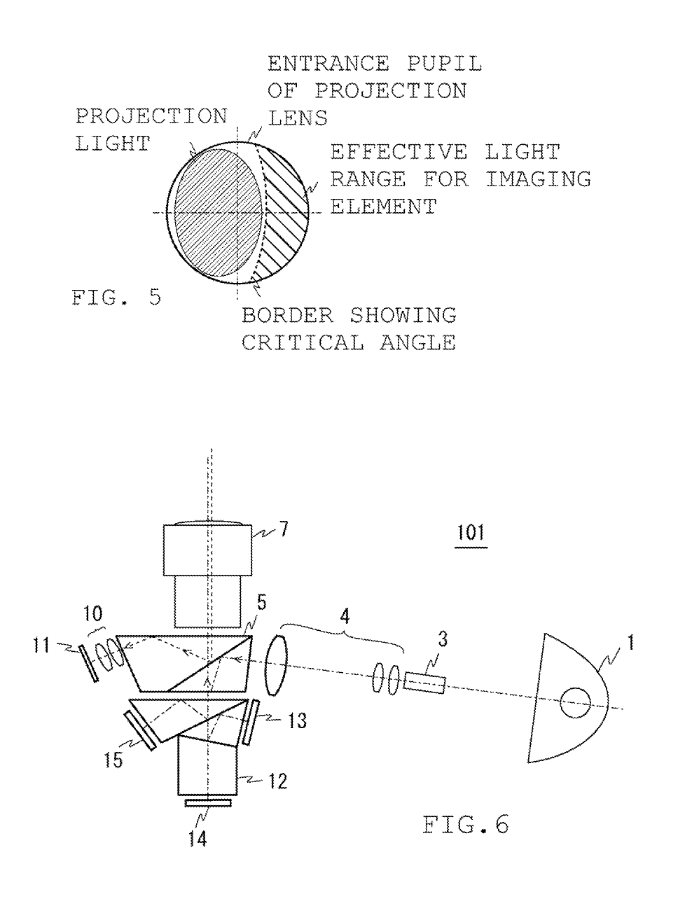

Further, though description has been given above for the single-plate type projector 100 having one DMD 6, the projector may be in a type having a plurality of panels. For example, in the case of a three-plate type projector 101 shown in FIG. 6, respective red, green and blue images generated by a DMD for R 13, a DMD for G 14, and a DMD for B 15 in place of the color wheel 2 and the DMD 6 shown in FIG. 1 are synthesized via a Phillips prism 12 and projected on the screen 8. Note that, in FIG. 6, optical paths of illuminating light guided to the DMD for R 13, the DMD for G 14, and the DMD for B 15 are omitted to be shown, but are set as being designed and arranged appropriately.

The present invention is not limited to the embodiments described above and, needless to say, can be variously changed without departing from the intention of the present invention. Note that, same reference numerals are assigned to the components showing the same function in the embodiments described above.

### REFERENCE SIGNS LIST

1: lamp
2: color wheel
3: rod integrator
4: condenser lens
5: TIR prism
5a: first prism
5b: second prism
6: DMD
7: projection lens
8: screen
9: light emitting element
10: magnification correction optical system
11: imaging element
12: Phillips prism
13: DMD for R
14: DMD for G
15: DMD for B
20: image processing portion
21: optical unit
22: imaging portion
201: irradiation position detecting portion
202: OSD drawing portion
203: signal processing portion
204: image synthesizing portion
S: light spot
P: pointing image
100, 101: projector

1. A projector comprising a TIR prism that reflects light from a light source to guide to an optical modulation element and causes the light reflected by the optical modulation element to be transmitted to output to a projection optical system, wherein

2. The projector according to claim 1, wherein
a film that reflects infrared light is provided on the reflective surface.

3. The projector according to claim 1, wherein
a film in which a reflection rate of a part becoming a valley between spectrums of projection light becomes high is provided on the reflective surface.

4. The projector according to claim 1,
wherein
the reflective surface causes the light reflected by the optical modulation element to be transmitted to output to the projection optical system as well as reflects the light that is made incident from the projection optical system to guide to the imaging element depending on angle characteristics.

5. The projector according to claim 1,
wherein
light of a light emitting element that is irradiated on a screen is reflected by the reflective surface of the TIR prism via the projection optical system and emitted from a surface on a side of the TIR prism, where the imaging element is arranged, to form an image on the imaging element.

6. The projector according to claim 1, wherein
the surface on the side of the TIR prism, where the imaging element is arranged, is vertical to center light of a photographed image.

7. The projector according to claim 1,
wherein
a wavelength band in which a reflection rate is high among reflection characteristics of the film provided on the reflective surface is overlapped with a wavelength band of the light emitting element that irradiates the screen.

8. The projector according to claim 1,
wherein
an irradiation position detecting portion that obtains irradiation position information showing an irradiation position of the light emitting element on the screen from the imaged image that is imaged by the imaging element,
an OSD drawing portion that generates an OSD image in which a predetermined pointing image is drawn corresponding to the irradiation position information,
an image synthesizing portion that synthesizes the OSD image with a projected image projected on the screen via the projection optical system to generate a synthesized image, and
the optical modulation element that performs optical modulation so as to project the synthesized image to emit to the TIR prism are included.

9. The projector according to claim 2, wherein
a film in which a reflection rate of a part becoming a valley between spectrums of projection light becomes high is provided on the reflective surface.

10. The projector according to claim 2, wherein
the reflective surface causes the light reflected by the optical modulation element to be transmitted to output to the projection optical system as well as reflects the light that is made incident from the projection optical system to guide to the imaging element depending on angle characteristics.

11. The projector according to claim 3, wherein
the reflective surface causes the light reflected by the optical modulation element to be transmitted to output to the projection optical system as well as reflects the light that is made incident from the projection optical system to guide to the imaging element depending on angle characteristics.

12. The projector according to claim 2, wherein
light of a light emitting element that is irradiated on a screen is reflected by the reflective surface of the TIR prism via the projection optical system and emitted from a surface on a side of the TIR prism, where the imaging element is arranged, to form an image on the imaging element.

13. The projector according to claim 3, wherein
light of a light emitting element that is irradiated on a screen is reflected by the reflective surface of the TIR prism via the projection optical system and emitted from a surface on a side of the TIR prism, where the imaging element is arranged, to form an image on the imaging element.

14. The projector according to claim 4, wherein
light of a light emitting element that is irradiated on a screen is reflected by the reflective surface of the TIR prism via the projection optical system and emitted from a surface on a side of the TIR prism, where the imaging element is arranged, to form an image on the imaging element.

15. The projector according to claim 2, wherein
the surface on the side of the TIR prism, where the imaging element is arranged, is vertical to center light of a photographed image.

16. The projector according to claim 3, wherein
the surface on the side of the TIR prism, where the imaging element is arranged, is vertical to center light of a photographed image.

17. The projector according to claim 4, wherein
the surface on the side of the TIR prism, where the imaging element is arranged, is vertical to center light of a photographed image.

18. The projector according to claim 5, wherein
the surface on the side of the TIR prism, where the imaging element is arranged, is vertical to center light of a photographed image.

19. The projector according to claim 2, wherein
a wavelength band in which a reflection rate is high among reflection characteristics of the film provided on the reflective surface is overlapped with a wavelength band of the light emitting element that irradiates the screen.

20. The projector according to claim 3, wherein
a wavelength band in which a reflection rate is high among reflection characteristics of the film provided on the reflective surface is overlapped with a wavelength band of the light emitting element that irradiates the screen.
